(19) United States
(12) Patent Application Publication
(10) Pub. No.: US 2024/0365485 A1
(43) Pub. Date: Oct. 31, 2024

(54) COMPLIANT MOUNTS FOR A DISPLAY BACK LIGHT UNIT

(71) Applicant: GOOGLE LLC, Mountain View, CA (US)

(72) Inventors: Guillermo Fabian Díaz Lankenau, Santa Cruz, CA (US); Antonio Yamil Layon Halun, Mountain View, CA (US)

(21) Appl. No.: 18/647,729

(22) Filed: Apr. 26, 2024

Related U.S. Application Data
(60) Provisional application No. 63/498,463, filed on Apr. 26, 2023.

(51) Int. Cl. H05K 5/02; F16M 13/02; G02B 30/10; H04N 23/90

(52) U.S. Cl. CPC H05K 5/0217; F16M 13/02; G02B 30/10; H04N 23/90

(57) ABSTRACT

Systems and methods are described for reducing thermal distortion in an optical display for use in a 3D stereoscopic video conferencing system. The thermal distortion can arise from operation of an array of LEDs in a back light unit of the display. Elements with compliance are included in a load path between a structure used for precision camera array mounting and its fixture points to reduce sensitivity to thermal cycles. The compliant elements, or flexures, can allow for linear expansion and prevent buckling of the backplate during thermal cycling, thus reducing motion of the cameras.

### CROSS-REFERENCE TO RELATED APPLICATION

This patent application claims priority to U.S. Patent Application No. 63/498,463 filed on Apr. 26, 2023, entitled “Compliant Mounts for a Display Back Light Unit,” the disclosure of which is incorporated by reference herein in its entirety.

### FIELD OF THE DISCLOSURE

The present disclosure relates to a system for three-dimensional (3D) video communication with improved image quality.

### BACKGROUND

Video communication systems, e.g., systems used for 3D video conferencing or video chats, facilitate collaboration in real space. However, some aspects of non-verbal communication, such as subtle facial expressions or body language can still be lost, which can compromise the quality of the interaction. Augmented reality (AR) or virtual reality (VR) systems can deliver a more comprehensive user experience, but they require users to wear headsets that transition the user from their natural environment into an immersive virtual space.

### SUMMARY

The present disclosure describes methods and systems for improving image quality in a 3D video communication system, by adding compliant mounts to absorb thermally induced strain in a light field display.

In some aspects, the techniques described herein relate to a system, including: a display having a backplate; a fixture point disposed on a surface of the backplate; and a flexure having a frame mounted to the backplate and a compliant member secured to the fixture point, wherein, in response to expansion of the backplate relative to the fixture point, the compliant member compresses by absorbing strain from the backplate.

In some aspects, the techniques described herein relate to an apparatus, including: an elongated metal frame having anchor points at opposite ends thereof; and an integral flexible element extending between the opposite ends such that when the elongated metal frame is secured at the anchor points and at a center of the integral flexible element, the integral flexible element deflects in response to transverse pressure applied to a mid-section of the frame.

In some aspects, the techniques described herein relate to a method, including: forming an optical display having a metal backplate with fixtures; embedding LEDs in the metal backplate; mounting multiple cameras to the optical display; and mounting a flexure device at one or more of the fixtures to absorb strain on the optical display due to thermal expansion.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a pictorial view of a 3D video communication system according to a possible implementation of the present disclosure.

FIG. 2 is a perspective view of a front side of a 3D light field display according to a possible implementation of the present disclosure.

FIG. 3 is an exploded view of different layers of an optical display, according to a possible implementation of the present disclosure.

FIG. 4A is a plan view of a rear side of a 3D light field display according to a possible implementation of the present disclosure.

FIG. 4B is a simulated thermal map of a backplate of an optical display, according to a possible implementation of the present disclosure.

FIG. 5 is a plan view of a rear side of a backplate of an optical display, according to a possible implementation of the present disclosure.

FIGS. 6A, 6B, and 6C illustrate placement of compliant mounts on a backplate of an optical display, according to a possible implementation of the present disclosure.

FIG. 7 is a magnified view of a compliant mount, according to a possible implementation of the present disclosure.

FIGS. 8A and 8B illustrate layouts of compliant mounts on a backplate of an optical display, according to a possible implementation of the present disclosure.

FIGS. 9A and 9B are simulated structural maps of an optical display, according to a possible implementation of the present disclosure.

FIG. 10 is a flow chart for a method of improving image quality of a 3D light field display, according to a possible implementation of the present disclosure.

Components in the drawings are not necessarily to scale relative to each other. Like reference numerals designate corresponding parts throughout the several views.

### DETAILED DESCRIPTION

An enhanced video communication system is possible in which a user's image is presented as a 3D model, without a need to wear an AR/VR headset. In the enhanced video communication system, for example, each user sits in a booth facing a light field display that includes a projection system and an array of cameras and lights directed at different angles. The light field display projects a 3D, hologram-like, life-size image of the user, for viewing by other, remote users. With such an arrangement, the video communication experience feels more realistic because the 3D imaging provides live volumetric capture that transmits body language and subtle facial expressions, not just a flat image of a “talking head.” Consequently, remote users can feel as though they are in the same room together.

3D lightfield displays can produce an autostereoscopic effect that enables an observer to perceive image depth (3D) without wearing special headgear. A stereoscopic effect can be created by a projection system that positions copies of an image in front of a user's left eye and right eye that are shifted horizontally relative to each other. An example 3D lightfield display uses lenticular optics to provide the autostereoscopic effect. The lenticular optics may be implemented as a series of vertically-oriented cylindrical camera lenses formed on a sheet, e.g., a lenticular film, that is fitted onto a display screen, to form an integrated 3D camera system. In some implementations, the lenses are formed as a 2D matrix covering the area of the display screen. In some implementations, the lenses are formed around an outer bezel of the display screen. In either arrangement, presenting and/or recording 3D video content requires the camera optics to be located with high precision relative to one another for the entirety of the video session.

At least one technical problem with such 3D light field displays that combine multiple video feeds into a composite 3D image is that the video quality is diminished if the position of any one of the cameras varies. Slight changes in camera position can result from geometric distortion of the lenticular film, resulting in flickering or jumping, or blurred features in the composite image. Such a geometric distortion can be thermally induced. That is, localized heating of the display can occur due to the operation of light emitting diodes (LEDs) and/or other electronic components, or even by sunlight incident on the display. LEDs can raise the temperature of the backplate of a display in the vicinity of the LED, from room temperature (e.g., about 25 degrees C.) to about 75 degrees C. Such heating causes structural components of the display to expand, Often, the expansion is uneven, which can cause warping as well. Consequently, existing commercial displays, used as computer monitors or televisions, lack the precision and the thermally stable geometry needed to sustain performance of the lenticular film, for high quality 3D video communication. Such displays are therefore not viable for hyper-realistic telepresence systems. For a camera projected at a distance of 1.2 m from a subject, camera motion is desirably less than about 200 μm, or the size of one display pixel. Currently available displays can experience about 0.1 mm to about 1.0 mm of relative motion between fixed points on the display.

The disclosed systems and methods provide a technical solution to thermally induced camera motion by adding compliant mounts, e.g., flexures, to the backplate of the display, to allow for thermal expansion. The flexures absorb strain to reduce distortion of the optical display.

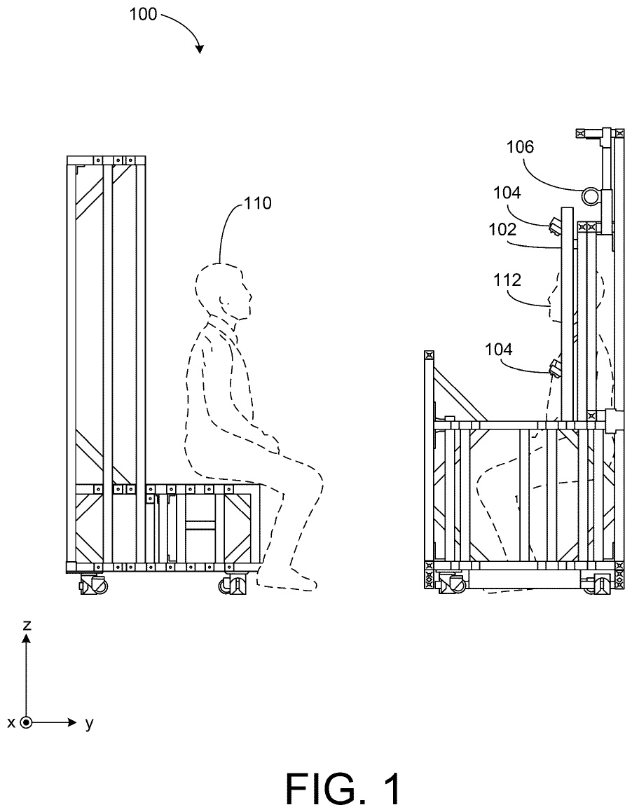

FIG. 1 shows a 3D video communication system 100 according to a possible implementation of the present disclosure. The 3D video communication system 100 includes a display 102, e.g., an optical display, onto which an array of display cameras 104 (two shown) are mounted in a precise arrangement. In some implementations, lenses of the display cameras 104 can be formed on a lenticular film attached to the display 102. Stress can alter positions of the display cameras 104 attached to the central area of the display 102 or to the perimeter of the display 102. Additionally, or alternatively, a frame camera 106 and/or light can be mounted on a separate frame above, below, or adjacent to the display 102.

A local user 110 can be seated opposite the display 102, to observe a 3D image 112 of a remote user. The local user 110 can be seated a few feet from the display 102, at a distance that would normally separate two people meeting together in the same room. The multiple display cameras 104 and the frame camera(s) 106 are focused simultaneously on the local user 110 to provide the remote user with a similar 3D image of the local user 110.

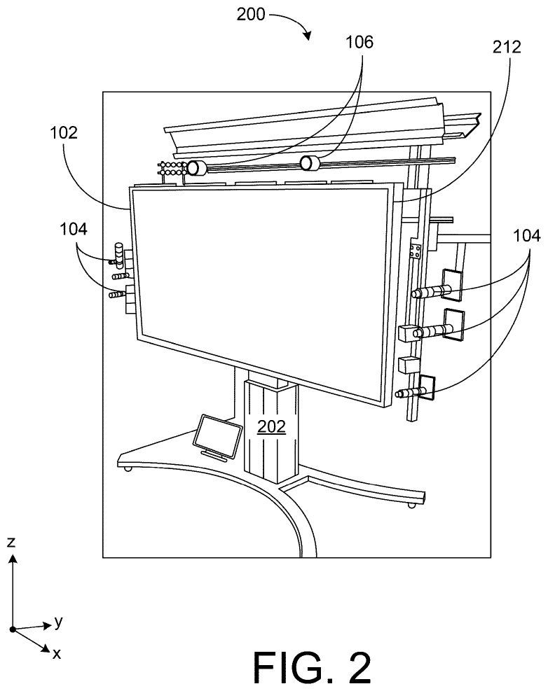

FIG. 2 shows a front view 200 of a prototype of the display 102, according to a possible implementation of the present disclosure. In FIG. 2, display cameras 104 (5 shown) are arranged around a perimeter, e.g., on a bezel, of the display 102. The display 102 can be supported by a frame 202. In some implementations, frame cameras 106 (2 shown) can be mounted to the frame 202, above, below, or to the sides of the display 102. A backplate 212 covers a back side of the display 102.

One of the challenges of the 3D video communication system 100 is to maintain accurate camera positions to successfully combine the video feeds from the various cameras. If the camera positions vary with respect to one another, the video image quality is diminished as the overlay of the video images becomes mis-aligned. While the display cameras 104 are subject to variations in their positions, even if the frame cameras 106 remain stationary, the relative positions of the various cameras may still vary.

In some implementations, a choice of materials used in the display 102 or in the frame 202 can minimize thermal distortions, for example, by substituting carbon fiber for aluminum. However, such materials may be cost-prohibitive. In some implementations, reducing ambient temperature variation from heat sources or exposure to sunlight can reduce thermal distortion. However, such environmental solutions would limit where the 3D video communication system 100 can be installed and are therefore impractical.

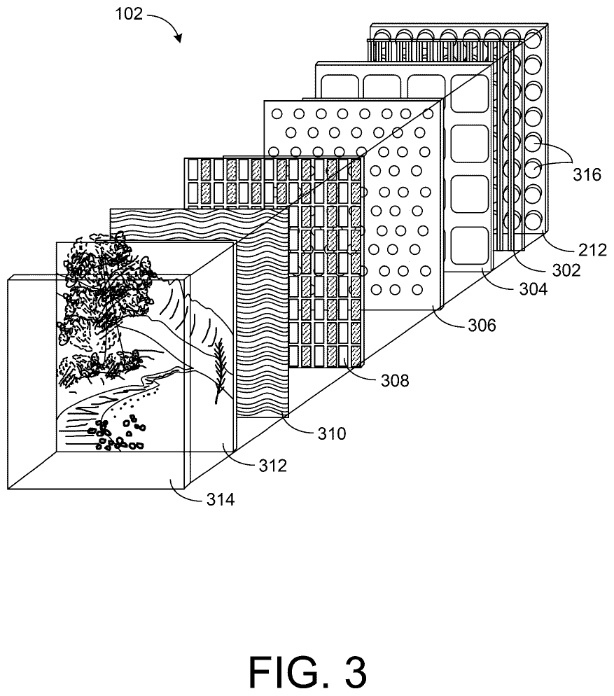

FIG. 3 is an exploded view showing various layers of a light field display, e.g., the display 102, according to a possible implementation of the present disclosure. The display 102 can include, for example, the backplate 212, a first polarizing layer 302, a thin film transistor (TFT) layer 304, a liquid crystal display (LCD) layer 306, a color filter layer 308, a second polarizing layer 310, a picture layer 312, and a cover 314. The backplate 212 includes LEDs 316 as light sources for the display 102. The LEDs can be arranged as a matrix array that occupies a large portion of the area of the display 102 so as to form a light field display. The first polarizing layer 302 can be placed adjacent to the LEDs 316. The first polarizing layer 302 can be, for example, a glass filter having a polarizing film deposited thereon. The TFT layer 304 can be placed adjacent to the LCD layer 306. The color filter layer 308 can be inserted on top of the LCD layer 306. The second polarizing layer 310 can be inserted next to the color filter layer 308. The picture layer 312 is where the projected image is formed. The cover 314 can be a glass layer that protects the picture layer 312.

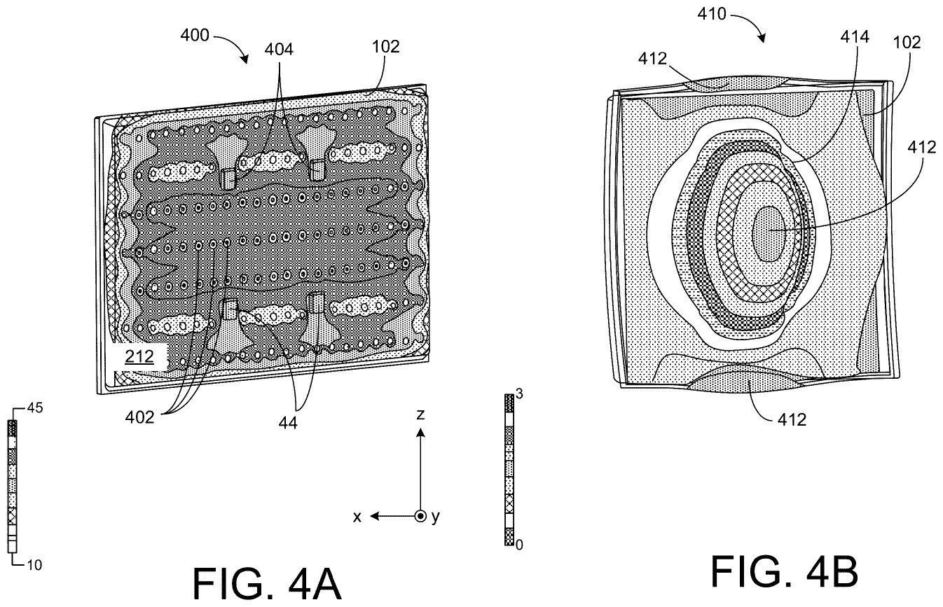

FIG. 4A is a simulated thermal map 400 of a front side of the backplate 212, according to a possible implementation of the present disclosure. The thermal map 400 illustrates thermally induced expansion of the backplate 212. In some implementations, the backplate serves as a heat sink as well as structural support for the display 102. In some implementations, the backplate 212 is made of structural steel to minimize bending, or buckling, in response to temperature cycling, wherein surfaces of the steel backplate 212 may radiate heat with an emissivity in a range of about 0.3 to about 0.7.

The thermal map 400 shows a steady state temperature profile of the backplate 212, in accordance with simulation results. Mounting points 404 are also indicated on the thermal map 400 (four shown). The mounting points 404, or fixture points, are locations of holes on raised surfaces near the center of the display where the backplate 212 can be attached to a stand or a wall mount. Locations of the mounting points 404 define load paths between the mounting points 404 and the cameras that are mounted to the display, e.g., to an outer frame of the display. Cameras can include an optical stack, e.g., a series of lenses, that can be quite heavy.

The mounting points 404 are locations where the backplate 212 is stiff, and therefore, as the backplate 212 heats up and expands, the fixtures remain stationary and thus they experience a high degree of strain and may exhibit bending or buckling due to the inherent normal stiffness of thin metal plates. The buckling results in larger motion at the edge of the display than would be expected from linear expansion. That is, the display edge motion, around the bezel where the cameras are mounted, is exaggerated by the rigid fixturing used on displays.

The thermal map 400 indicates point hot spots 402 corresponding to internal electronic components within the display 102, adjacent to the backplate 212. In some implementations, the point hot spots 402 can correspond to locations of the LEDs 316 within the display 102, of which there may be, for example, 200 to 400 LEDs per display, arranged in rows. In some implementations, the point hot spots 402 are hotter near the center of the display 102 than at the edges. In some implementations, an average temperature change ΔT, associated with hot spots 402 can be about 28.5 degrees C., as predicted by a simulation used to generate the thermal map 400.

FIG. 4B is a simulated deformation map 410 of a front side of the backplate 212, according to a possible implementation of the present disclosure. The deformation map 410 shows a static structural profile of the display 102, in accordance with simulation results, using finite element analysis (FEA). The deformation map 410 indicates thermal distortions 412 (three shown), at the center of the display 102, and at central portions of the top and bottom edges of the display 102. The thermal distortion 412 located at the center of the display 102 coincides with the most extreme point hot spots 402. In some implementations, a deformation-free region 414, e.g., a circular region, may exist.

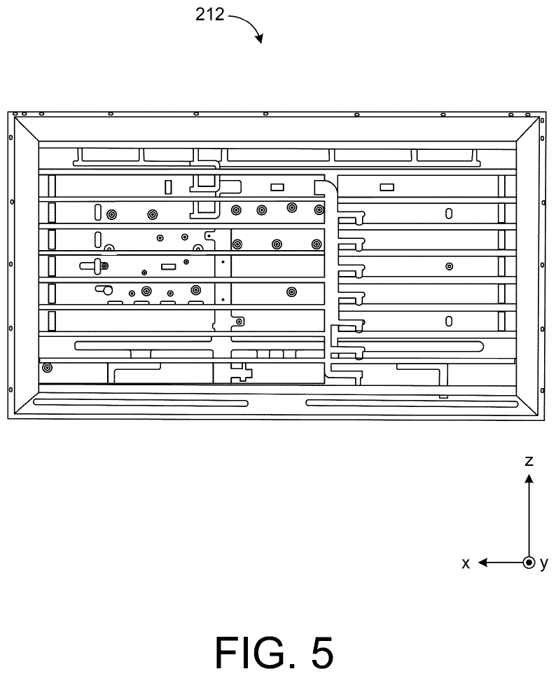

FIG. 5 shows a rear side of the backplate 212, according to a possible implementation of the present disclosure. The backplate 212 can be stamped from sheet metal, e.g., including materials such as steel, aluminum, or various metal alloys. In some implementations, an array of LEDs can be embedded in the backplate 212. The array can include, for example, between 200 and 400 LEDs. The backplate 212 serves as a heat sink for the LEDs and a structure for the overall optical display shown in FIG. 2, which includes the layers shown in FIG. 3. The backplate 212 can support a significant weight. In addition, for a 3D display, cameras can be mounted to the backplate 212, e.g., around a perimeter (bezel) of the backplate 212, or on a surface of the back plate 212. It is desirable to protect the cameras from thermal distortion of the sheet metal of the back plate 212, to reduce camera motion so that relative distances between the cameras remain substantially constant during use. The thermal distortion can be caused by heat sources, e.g., internal heat sources such as the LEDs, or external heat sources in the environment of the display 102. In some implementations, each LED can emit power in the form of heat, in a range of about 0.9 W to about 1.1 W, for a total of about 300 W of heat emitted by the LED array.

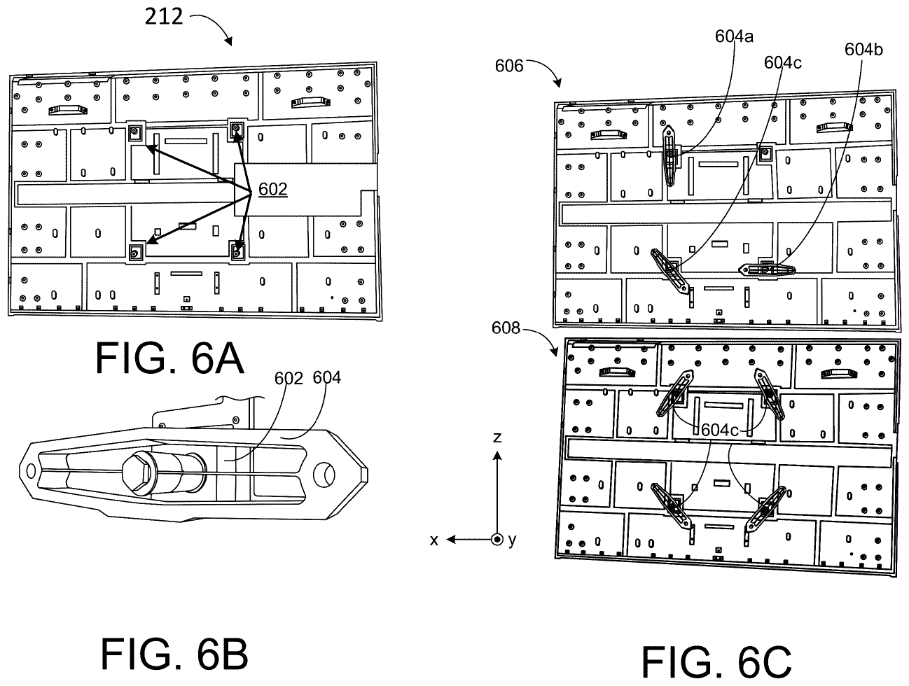

FIGS. 6A, 6B, and 6C illustrate examples of a prototype flexure geometry and layouts for the backplate 212, according to a possible implementation of the present disclosure.

FIG. 6A shows, as an example, locations of four mounting points, or fixture points 602, disposed on a surface of the backplate 212, where compliant mounts 604 can be attached to the backplate 212. The backplate 212 can have any number of fixture points 602. FIG. 6B shows an example of a compliant mount 604, also known as a flexure device, or flexure.

FIG. 6C shows two layouts of compliant mounts 604 on the backplate 212. In a first layout 606, shown in a top portion of FIG. 6C, three compliant mounts 604 are attached to the backplate 212—flexure 604a, flexure 604b, and flexure 604c—at a subset of the four fixture points 602. The flexure 604a is oriented vertically along the z-axis, the flexure 604b is oriented horizontally along the x-axis, and the flexure 604c is oriented at a 45 degree angle, so that the three flexures are mounted symmetrically around a single fixture point 602, coinciding with the flexure 604c.

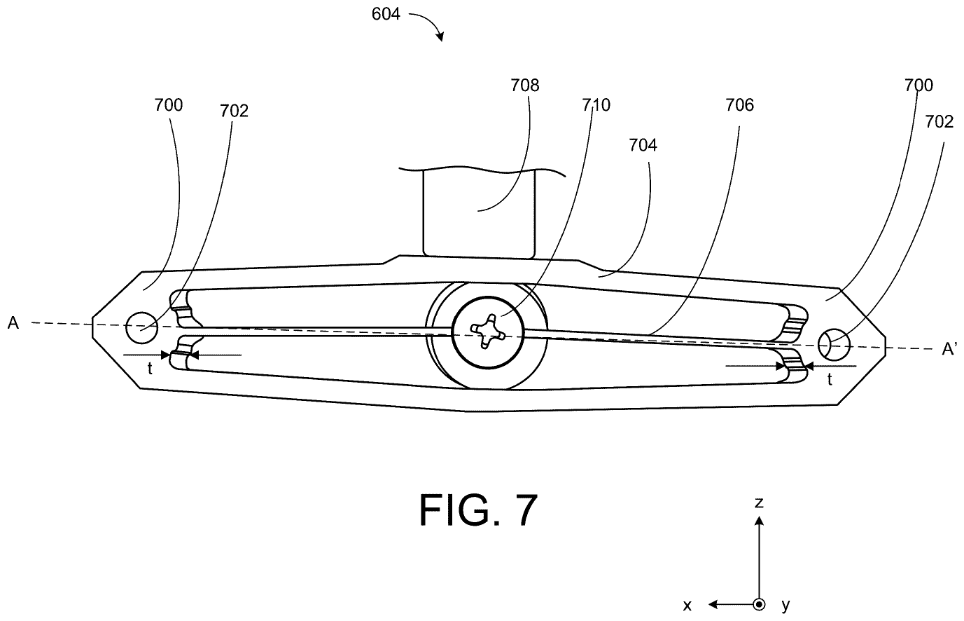

In a second layout 608, shown in a bottom portion of FIG. 6B, a flexure 604c is attached to each one of the fixture points 602 on the backplate 212, at a 45-degree angle. The display 102 can be expected to expand radially outward from its center as it heats up. Thus, the second layout 608 orients the flexures 604c at 45-degree angles, so that the flexures are arranged symmetrically around the center of the display. In this arrangement, the flexures will be compliant in the direction of thermal expansion, as will be explained in more detail with respect to FIG. 7. A variety of other layouts can be used in addition to the two examples shown in FIG. 6B.

FIG. 7 is a magnified view showing details of the compliant mount 604, according to a possible implementation of the present disclosure. The compliant mount 604 is direction-specific in that it is designed to be compliant in a direction of thermal expansion. In some implementations, the compliant mount 604 is a steel or titanium flexure, e.g., a structure that includes at least one flexible element. In some implementations, the compliant mount 604 has a length in a range of about 105 mm to about 135 mm and a width in a range of about 45 mm to about 55 mm.

The compliant mount 604 serves as an intermediary compliant element in that the display 102 can be mounted to the compliant mount 604, which in turn, can be bolted to a wall. Elements of the compliant mount 604 include opposite ends 700, holes 702, an elongated metal frame 704, and a flexible member, e.g., a compliant member 706. The compliant member 706 is an integral flexible element extending between the opposite ends 700.

The opposite ends 700 serve as anchor points of the compliant mount 604. The opposite ends 700 of the compliant mount 604 can be held fixed by fasteners such as sheet metal hooks, or the opposite ends 700 can receive fasteners, e.g., bolts, through the holes 702 to mount the elongated metal frame 704 to the backplate 212. The elongated metal frame 704 can have an aspect ratio (length:width) in a range of about 2.0 to about 2.5, wherein the elongated metal frame 704 has a (horizontal) length in the x-direction, a (vertical) width in the z-direction, and a depth, or thickness t, in the y-direction.

While the opposite ends 700 are held fixed, the center of the compliant mount 604 is secured to the fixture point 602 by attachment to a center post 708 located at the fixture point 602 of the backplate 212. In some implementations, a screw 710 tightens down onto the compliant member 706 to couple the compliant member 706 to the center post 708. The compliant member 706 is aligned with an axis A-A′ along its length, e.g., in the x-direction as shown in FIG. 7. The axis A-A′ of the compliant member 706 can be oriented transverse to expansion of the backplate 212. Accordingly, as the backplate 212 expands, the center post 708, which is attached to the backplate 212, moves the compliant member 706 in a transverse direction., That is, the center post 708 exerts transverse pressure on a mid-section of the compliant member 706, causing the compliant member 706 to deflect vertically, in the z-direction. In some implementations, the thickness t of the elongated metal frame 704 is at least four times greater than the thickness of the compliant member 706. Such relative dimensions can ensure that the compliant member 706 deflects relative to the elongated metal frame 704, which remains anchored, e.g., stationary, at the opposite ends 700. In some implementations, the (vertical)_width of the compliant member 706 is about 10 times thinner than the depth, of the compliant member 706, to ensure that the compliant member 706 bends easily in the z-direction.

As the compliant member 706 is stretched, it acts as a spring, or a strain absorber, thus relieving tension on the backplate 212. In some implementations, the compliant member 706 can deflect by a distance between 0.1 mm and 1.0 mm. In some implementations, the compliant member 706 has a thickness:width ratio in a range of about 10.0 to about 25.0, wherein the thickness is the dimension of the compliant member 706 along the y-axis and the width is the dimension of the compliant member 706 along the (vertical) z-axis. In some implementations, sensitivity of the compliant mount 604 can be adjusted, e.g., by tightening or loosening the screw 710. Such an adjustment cab be made according to a strain predicted by a simulation of the thermal expansion, e.g., using the simulated thermal map 400 as a guide.

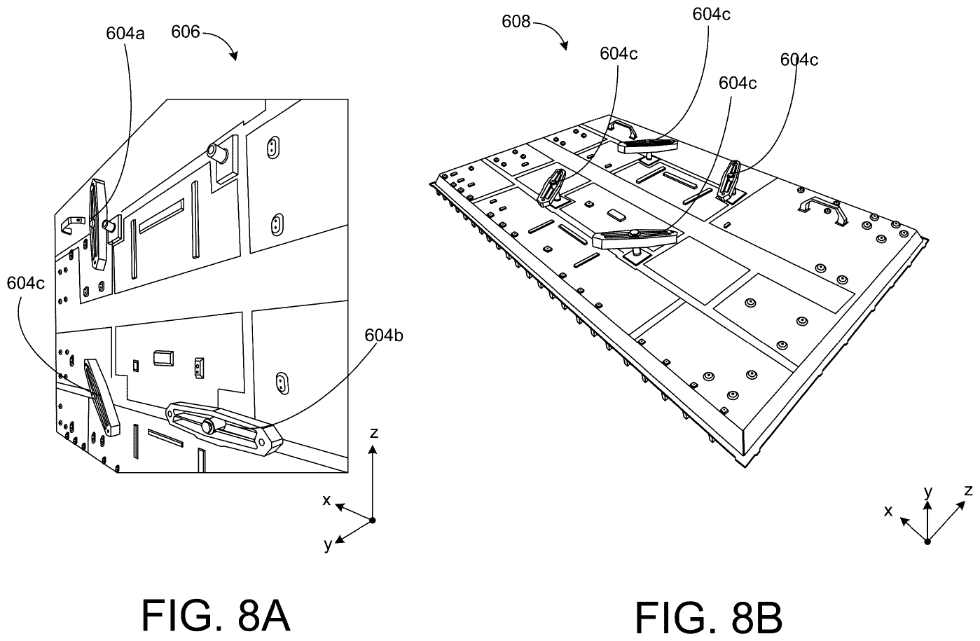

The compliant member 706 as shown in FIG. 7 acts as a co-linear leaf spring. The co-linear leaf spring has greater fore/aft stiffness, e.g., in the z-direction shown in FIG. 8A, than could be achieved by other types of flexible members, for example, parallel leaf springs arranged in a compliant four bar linkage. A four bar linkage would travel in the compliant direction, indicated by the green arrow in FIG. 8A, through a slight arc, whereas the co-linear leaf spring described herein would tend to move in a straight line in the compliant (z) direction. The simplicity of the flexure as shown in FIG. 7 makes this design easier to manufacture than a four bar linkage. Simulations show that adding flexures of the type shown in FIG. 7 in the fixturing load path can absorb about 30%-40% of the strain on the backplate 212 for a 65-inch display 102 and can reduce thermal distortion of the backplate by about 40%. Consequently, camera motion can be reduced by about 40%.

FIGS. 8A and 8B show details of the three-flexure layout and the four-flexure layout, respectively, shown in FIG. 6B, according to a possible implementation of the present disclosure. Because the compliant mounts 604 shown in FIG. 7 are direction-specific, they can support the display 102 in a manner that is stiff in the nominal loading directions but compliant in the direction of thermal expansion. Consequently, the compliant mounts 604 are placed on the backplate 212 so that the compliant direction of the flexures, that is, the direction of deflection of the compliant member 706, is oriented parallel to the expansion direction of the display 102 and orthogonal to the nominal loading direction.

In FIG. 8A, the three compliant mounts 604 are oriented relative to expansion from the top right mounting point, which is fixed and supports loads in all directions (x-, y-, and z-). The top left mounting point supports vertical (y-direction) and z-direction loads. The two bottom mounting points only need to support the display 102 fore-aft in the z-direction.

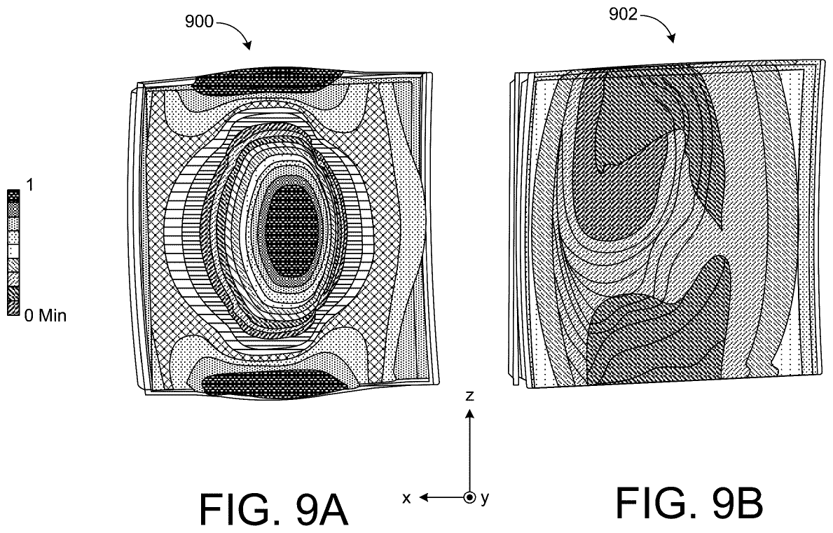

FIGS. 9A and 9B are simulated maps 900 and 902, respectively, of the backplate 212, according to a possible implementation of the present disclosure. The simulated maps 900 and 902 show structural deformation of the interior surface of the backplate 212 before and after adding compliant mounts 604. FIG. 9A shows deformation of the display 102 as it expands from a central point, while mounted e.g., to a wall, at four fixed points without the benefit of the compliant mounts 604. The display 102 experiences significant buckling, particularly at its center. The deformation shown in FIG. 9A is caused by 300 W of LED thermal emission.

FIG. 9B shows deformation of the display 102 with the use of three flexures, e.g., the compliant mounts 604, in the arrangement shown in FIG. 8A. The addition of the compliant mounts 604 has changed the deformation pattern and reduced the maximum amount of display edge deflection. The simulated result shown in FIG. 9B suggests that the deformation of the display 102 can be reduced or eliminated by the use of compliant mounts 604 at the fixture points 602.

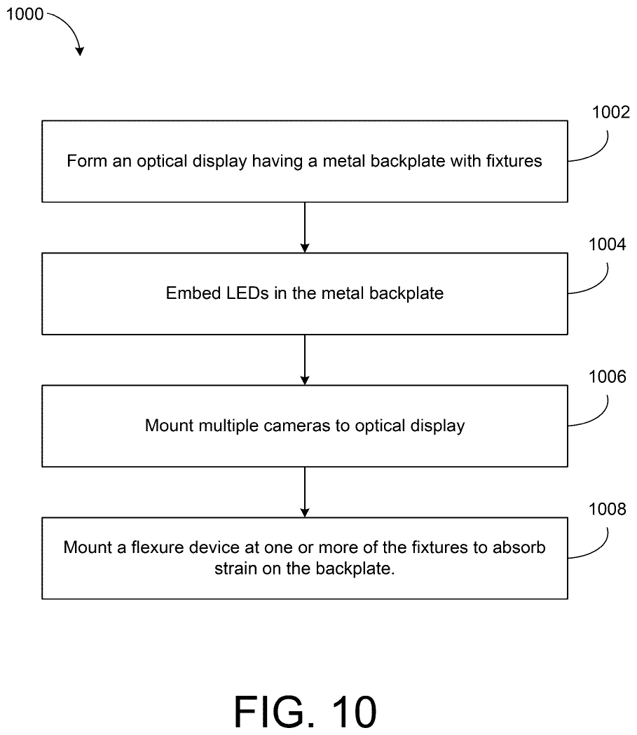

FIG. 10 illustrates a method 1000 for improving image quality of a 3D light field display, according to a possible implementation of the present disclosure. Operations of the method 1000 can be performed in a different order, or not performed, depending on specific applications. The method 1000 may be performed using the apparatus shown in FIGS. 1, 2, 3, 4A, 4B, 5, 6A, 6B, 6C, 7, 8A, 8B, 9A, and 9B. The method 1000 includes preliminary operations that occur prior to a video session. It is noted that the method 1000 may improve thermal stability of the display 102 but may not completely eliminate thermal distortions affecting the display 102. Accordingly, it is understood that additional processes can be provided before, during, or after the method 1000, and that some of these additional processes may be briefly described herein.

The method 1000 includes, at 1002, forming an optical display, e.g., the display 102, that includes the metal backplate 212, according to a possible implementation of the present disclosure. The metal backplate 212 can include mounting points, e.g., fixtures such as the fixture points 602, where the display 102 can be bolted to a fixed structure, such as a wall.

The method 1000 further includes, at 1004, embedding LEDs in the metal backplate 212, as illustrated in FIGS. 4A and 5, according to a possible implementation of the present disclosure.

The method 1000 further includes, at 1006, mounting multiple cameras to the optical display 102, as illustrated in FIGS. 1 and 2, according to a possible implementation of the present disclosure.

The method 1000 further includes, at 1008, mounting a flexure device, e.g., the compliant mount 604, at one or more of the fixtures, e.g., fixture points 602, to absorb strain on the backplate 212 of the optical display 102, as shown in FIGS. 6A, 6B, 6C, 7, 8A, and 8B, according to a possible implementation of the present disclosure. In some implementations, the compliant mount 604 can be oriented so as to cause the compliant member 706 to deform linearly in response to motion of the backplate 212.

The method 1000 can be employed in systems other than the 3D video communication system 100, e.g., in the context of other systems that feature multiple cameras in a precise arrangement. Such systems can include, for example, smart phones that include multiple cameras, autonomous vehicles that employ cameras together with LIDAR, GPS-based mapping programs that rely on immersive street-view images, mobile robot vision systems, camera arrays used for precision motion capture, and interactive touch displays that incorporate cameras.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below”, or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A system, comprising:
a display having a backplate;
a fixture point disposed on a surface of the backplate; and
a flexure having a frame mounted to the backplate and a compliant member secured to the fixture point, wherein, in response to expansion of the backplate relative to the fixture point, the compliant member compresses by absorbing strain from the backplate.

2. The system of claim 1, wherein the backplate has a plurality of fixture points and a flexure is mounted to the backplate at each one of the fixture points.

3. The system of claim 1, wherein the backplate has a plurality of fixture points and a flexure is mounted to the backplate at each of a subset of the fixture points.

4. The system of claim 1, wherein the system includes multiple flexures, and the multiple flexures are mounted symmetrically around a single fixture point.

5. The system of claim 1, wherein an axis of the compliant member is oriented in a direction transverse to expansion of the backplate.

6. The system of claim 1, wherein the backplate includes at least one of steel or aluminum.

7. The system of claim 1, wherein the flexures reduce thermal distortion of the backplate by about 40%.

8. The system of claim 1, wherein the expansion of the backplate is thermally induced.

9. An apparatus, comprising:
an elongated metal frame having anchor points at opposite ends thereof; and
an integral flexible element extending between the opposite ends such that when the elongated metal frame is secured at the anchor points and at a center of the integral flexible element, the integral flexible element deflects in response to transverse pressure applied to a mid-section of the frame.

10. The apparatus of claim 9, wherein the integral flexible element includes at least one of steel or titanium.

11. The apparatus of claim 9, wherein the integral flexible element has a thickness-to-width ratio in a range of about 10.0 to about 25.0.

12. The apparatus of claim 9, wherein the integral flexible element deflects by a distance of about 0.1 mm to about 1.0 mm.

13. The apparatus of claim 9, wherein the elongated metal frame is mounted to a first object and the center of the integral flexible element is secured to a second object, so that the integral flexible element deflects in response to motion of the first object relative to the second object.

14. The apparatus of claim 13, wherein the first object is a fixed structure, and the second object is a movable structure.

15. The apparatus of claim 13, wherein the first object is a display, and the second object is a fixture point of the display.

16. The apparatus of claim 9, wherein the anchor points are configured with holes to receive fasteners.

17. A method, comprising:
forming an optical display having a metal backplate with fixtures;
embedding LEDs in the metal backplate;
mounting multiple cameras to the optical display; and
mounting a flexure device at one or more of the fixtures to absorb strain on the optical display due to thermal expansion.

18. The method of claim 17, wherein mounting the flexure device includes mounting the flexure device in an orientation such that the flexure device deforms linearly in response to motion of the backplate.

19. The method of claim 17, wherein a sensitivity of the flexure device is adjusted according to a strain predicted by a simulation of the thermal expansion.

20. The method of claim 17, wherein the flexure device is compliant in a direction of the thermal expansion.
